(19) United States
(12) Patent Application Publication
(10) Pub. No.: US 2008/0042378 A1
(43) Pub. Date: Feb. 21, 2008

(54) Load Carrier

(76) Inventors: Toni Dick, Kreuzau (DE); Kornelis Gerard Van Vliet, Aalsmeer (NL)

Correspondence Address: WILLIAM COLLARD;COLLARD & ROE, P.C., 1077 NORTHERN BOULEVARD, ROSLYN, NY, 11576, US

(21) Appl. No.: 11/628,372

(22) PCT Filed: Jun. 1, 2005
(86) PCT No.: PCT/DE05/00990

§ 371 Date: Jan. 16, 2007

(30) Foreign Application Priority Data
Jun. 2, 2004 (RO) A 2004 00499 AO
Mar. 17, 2005 (DE) 20 2005 004 335.4

(51) Int. Cl. B62B 11/00

(52) U.S. Cl. 280/29

(57) ABSTRACT

The invention relates to different types of load carriers, more specifically to rollable load carts and load pallets. According to a first aspect of the invention, RFID transponders are advantageously disposed. According to a second aspect of the invention, corner posts are fixed to a base element in order to allow for space-saving transport of the empty load carriers.

The invention relates to a load carrier.

Load carriers serve for receiving load collectors filled with load and/or for receiving the load itself for transport and storage thereof. Widely used load carriers are pallets such as Euro pallets made from wood, plastic material, metal or other materials. Usually, pallets have runners and are slightly lifted by loaders causing them to move laterally. Said runners are in the form of logs acting as legs and are provided underneath a loading surface.

Movable load carriers are also widely to be found on the market. They have a plate-shaped base element with caster wheels disposed on their underside. In most cases, at least two of these are fixed caster wheels, that is to say suspended immobilized caster wheels. Two other caster wheels are often pivotally carried. Such type load carriers are often provided with corner posts so that a rack having a plurality of rack planes can be erected for receiving therein load or load collectors.

Load collectors are understood to refer more specifically to crates or small containers. Such type load collectors facilitate handling of small goods in particular. They moreover make it easier to stack many goods.

In the transportation of goods and freight, the use of such load carriers and load collectors has proved efficient for years. An improved handling system of such type load carriers and load collectors with magnetic identification cards is shown in RO 2000/00768 A.

For several years, the logistics with such type load carriers and load collectors has been increasingly rendered automatically recordable. Tags with bar codes are directly stuck onto the load carrier, the load collectors or the load itself for this purpose. These tags can be read out using a corresponding reader that is to be held in front of the bar code.

In order to allow for transportation of larger volumes of goods and for automatically handling them, systems permitting identification via radiofrequencies are increasingly used. These systems are referred to as RFID systems. RFID stands for Radio Frequency Identification.

An RFID system comprises a chip, which is provided with an antenna and is also called a transponder, as well as a reader/writer also referred to as a scanner. A transponder consists of a chip having a simple processor, an antenna and a memory.

A distinction is made between passive and active transponders. Passive transponders receive their operational energy from the radio waves received. The data stored can only be read out. Moreover, the storing capacity and the coverage of the antenna are smaller as compared to active transponders. Active transponders have a battery of their own for their energy supply. The memory can be read and written. The storage capacity and the coverage are much greater.

Since passive transponders are much less expensive than active transponders, they are used more often. Concretely, passive transponders are stuck onto the packaging for identification during the transfer of the goods. Accordingly, the transponder is conceived to be a one-way product.

As a result, a new transponder needs to be stuck with great precision on the right place at each transfer of goods. The right location of the transponder is of paramount importance for its function in order for noise fields to be excluded. Noise fields are more specifically expected to occur in the case of metal, water, impacts and dirt. Such noise fields have a very strong influence on the functioning of the transponder.

It is the object of the invention to provide an improved load carrier that may be handled automatically.

This object is solved by a load carrier having a more specifically movable or pallet shaped RFID transponder, said RFID transponder being disposed on a transponder carrier that is non-twistably and non-displaceably connected to the load carrier, irrespective of the load disposed or adapted to be disposed on said load carrier.

In accordance with this aspect of the invention, the transponder is not connected to the load in any way but is instead non-twistably and non-displaceably directly connected to the load carrier. The fixation guaranties the safe reading of the detection chip: RFID transponders are usually read out by scanner gates. They have stationary scanner antennae. Since the transponder carrier is non-twistably and non-displaceably fastened, the transponder may already be oriented by the carrier into the direction ideal for reading. With a pallet or a movable cart, the long sides are particularly suited for this purpose.

In the case of a movable load carrier, it is proposed that the transponder carrier be fastened to a suspension of a fixed caster wheel. It has already been explained that a fixed caster wheel is not pivotal with respect to the base plate of the load carrier. As a result, the orientation of the caster wheel with respect to the load carrier as a whole is always the same. Accordingly, the transponder carrier is not pivotal either in its direction with respect to the load carrier when the transponder carrier is on the fixed caster wheel. Moreover, the fixed caster wheel lies underneath the actual load and, as a result thereof, in a space into which no stacked load of whatever type will engage.

In a preferred embodiment, the transponder carrier forms a grip around the suspension of the fixed caster wheel toward the caster wheel. Usually, fixed caster wheels are usually fastened by two bearing sheets acting as the suspension. A transponder carrier forming a grip around such a suspension is already quite well fixed in itself. Moreover, the transponder carrier can be readily adapted to the exact orientation of the suspension.

For such type suspension sheets in particular, it is advantageous if the transponder carrier comprises two spaced apart and/or angularly disposed slots. These slots facilitate adjustment and fixation of the transponder carrier.

It is very economical if the transponder carrier uses the same fastening means as the suspension. Suspensions of fixed caster wheels for example are often screwed to the base plate of the load carrier. It is indicated to provide the transponder carrier with at least one wing that pivots from that location at which the transponder chip as such is to be retained toward a fastening screw. In this way, the transponder carrier can be readily and firmly connected to a fixed caster wheel by screwing these together. At need, a longer screw must be utilized for this purpose. The length of the existing screw may suffice, though.

As to wording, it is noted that within the frame of this application, it will be question of the transponder as such or of the transponder chip as such if the electronic components of the transponder are referred to. Strictly speaking, the transponder is differentiated in a chip element having an area of about 1 mm² and in an antenna covering in most cases a field of 90 mm in length and 20 mm in width. The chip as such is often disposed in the center of the entire area covered by the antenna. As used herein, this component consisting of the chip element and the antenna will be referred to as the transponder as such.

It is proposed that the transponder carrier be configured in such a manner that the transponder chip as such is spaced at least about 10 mm, preferably at least about 15 mm, more specifically at least about 20 mm apart from the suspension. The inventors have found that such a rearward spacing between the transponder chip and the suspension allows obtaining improved read-out results.

It has already been explained that it is advantageous if the transponder carrier orients the transponder toward one side edge of the load carrier. On a pallet or a movable load carrier that is caused to travel longitudinally through a scanner gate, the side edges can be read out best.

Sporadically, ground antennae can still be found. They are however difficult to assemble and are subjected to high mechanical load. Ground antennae are therefore utilized less and less often.

For positioning the transponder, it is noted that on ground antennae transponders may also be fastened inside on the wheel, more specifically on a fixed caster wheel. A transponder carrier with a transponder, said transponder carrier being oriented inward, that is beneath the movable load carrier, on a suspension of a fixed caster wheel, is also advantageous irrespective of the other features of the present invention.

In an alternative embodiment, the transponder carrier is sunk in a recess in the load carrier. A transponder carrier disposed in this way provides per se an effect of benefit, even if it is not positioned so as to be secured against twisting and displacing. By having the arrangement sunk in the very load carrier, the load carrier protects the transponder carrier against mechanical load as well as against radiation, thermal and humidity load. If, in addition thereto, it is ensured that the transponder carrier is not allowed to become twisted or displaced, it is made certain that it can be optimally read out.

A sunken transponder carrier may at least substantially be configured in the shape of a plug allowing for the easiest possible insertion into a recess provided in the transponder carrier. In the case of a plug-shaped transponder carrier, more specifically of an at least approximately cylinder-shaped transponder carrier, one simple hole in the load carrier suffices to receive the transponder carrier. The transponder carrier may for example have a roughly cylindrical shape with a diameter of about 2.5 cm. In this case, a corresponding hole may be made into the load carrier so as to provide for a little clearance for the transponder carrier plug to be readily pluggable therein.

If the transponder carrier comprises a clamping registration fit with the recess at the opening thereof, the transponder is best protected against humidity. In order to find means providing the tightest seal between the transponder carrier and the load carrier, a sealing ring made from a rubber material for example may cause the clamping registration fit to occur between the transponder carrier and the opening of the recess.

In a particularly preferred embodiment, an arrangement of the invention consisting of a load carrier and a transponder carrier comprises a detent device that opposes a destruction-free removal and/or rotation of the transponder carrier out of the recess. Such a detent device may for example be provided by a retaining spring, one spring element thereof projecting sideways from the transponder carrier and compressing during introduction into the recess in the load carrier. As soon as the transponder carrier has the intended orientation and depth in the recess provided in the load carrier, the recess should widen sideways within the load carrier so that the spring elements be capable of snapping outward. Now, the transponder carrier can no longer be twisted or pulled out without having to overcome the spring at the expense of a great force and without the spring being destroyed thereby. Such a locking engagement reliably protects the transponders against manipulation, once they have been introduced.

It is understood that a transponder carrier suited for use in a described arrangement is also advantageous in itself. This applies in particular for a plug-shaped transponder carrier.

Furthermore, it is understood that the invention proposed is not limited to load carriers such as movable carts and pallets. RFID-transponders may also be disposed in the manner proposed on a transponder carrier that is non-twistably and non-displaceably connected to a load collector irrespective of the load disposed or adapted to be disposed in the load collector.

According to an independent aspect of the invention, a transponder carrier may also well be disposed on a bar protruding from the load carrier toward the front, more specifically in or on a brand lock. Such locks are often used for clearly identifying and allocating a load carrier. If the lock is removed or replaced by an unauthorized person, it will automatically be destroyed. The locks are often hanging on bars that are disposed on frames, more specifically on the front side of a load carrier. The aspect presented herein disposes the brand lock on the front side, slightly outside of the actual load carrier, so that it is located in an exposed position and can be read out both from the side and from the top or the bottom. Depending on the sensitivity of the scanners, it may be disposed on the bar so as to be pivotal or dangling thereon or so as to be non-twistably and non-displaceably secured thereon. In any case, the size of the space protected from dirt and humidity should be increased over hitherto known brand locks in order for the transponder carriers to be securely accommodated and protected.

Another aspect of the invention deals with load carriers with corner posts that may be erected in racks. Such type load carriers are known, inter alia, from U.S. Pat. No. 3,693,733 and U.S. Pat. No. 2,827,302. Both patents show load carriers with a base element and with removable corner posts. The corner posts are removable in order to allow stacking the empty load carriers so that they take particularly little volume. Stacked in this manner, the load carriers can only be secured against being displaced relative to each other at great expense, though.

The document DE 28 00 575 C2 shows load carts the base elements of which can be stacked very securely. However, the transport of the empty load carriers still causes the problem of having to stow away the corner posts. A corner post is often significantly longer than the largest dimension of the base element. Accordingly, the posts are very cumbersome when folding the load carriers.

In practice, further load carriers are known which have stacking devices similar to the carts of the document DE 28 00 575 C2. The corner posts are folded for stacking the empty load carriers. This however is a mechanical process that is very prone to wear. During the lifetime such a post must have, it will be folded approximately 100,000 times. The risk for the corner post joints to fail is therefore great.

The object of the now presented aspect of the invention is to provide for a load carrier that is better configured for empty travels.

This object is achieved by a more specifically rollable load carrier with a base element and posts, said posts being adapted to be erected at right angles to the base element via post retainers in order to hold rack planes for load above the base element and said posts being capable of being removed from the posts retainers for the space-saving transport of empty load carriers, means for fixating the posts in the horizontal position being provided on the base element.

This aspect of the invention circumvents in a surprisingly simple way the problem of the wear-prone hinges of the foldable corner posts. In spite thereof, the corner posts can adopt exactly defined positions for the transport of the empty load carriers. In this way, they do not randomly slide about, which could lead to hazards or damages. The horizontal position, meaning largely parallel to the base element, ensures that the posts will not affect the stacking height of the empty load carriers. More specifically, the fixed posts may be inclined at an angle not exceeding 15°, preferably not exceeding 10°, with respect to a plate of the base element.

The stacking height will not be increased by a slightly oblique lying post if the angle between the fixed post and the base element is so acute that the post is lower than the post retainer, at least above the overall surface of the base element.

Means for fixing the posts in the horizontal position may also be retrofitted on the existing load carriers. This is particularly easy if they are disposed on the base element, separately from the post retainers. It is in any case preferred that the fixing means be distinct from the post retainers.

In order to allow secure absorption of high dynamometric loads during transport without the fixed corner posts leaving the fixation, it is proposed to provide two widely spaced-apart receptacles for each post. These receptacles may more specifically be disposed on the rim of the base element.

With hollow posts in particular, the fixation can be easily achieved by having a first receptacle engaging longitudinally into the post at a first post end, whilst a second receptacle forms, at the second post end, at least a partial surrounding grip about said post or engages transversely thereinto.

If at least one receptacle is configured to be pivotal, it can be pivoted away in such a manner for using the loaded load carrier that the risk of damaging the load is minimized. For fixing the posts once the load carrier has been emptied, the receptacle can be pivoted into its fixing position.

For disposing two empty load carriers side by side so that they occupy as little space possible, it is advantageous to fix the removed posts at a slight incline flat on the base element. In this way, the two side-by-side load carriers can be oriented in such a way that the inclines of the posts on the two base elements are directed in the same way so that the protruding posts of the first load carrier extend above a low portion of the posts of the second load carrier. As a result, the protruding post parts of the first load carrier lie in the space above the second load carrier that is not used anyway, even if other load carriers are being stacked onto these two load carriers.

The read-out results of the RFID transponder are generally increased if the transponder carrier is made from a non-metallic material.

The invention will be better understood herein after with reference to the drawing. In said drawing, components having an identical function may be labelled with the same reference numeral.

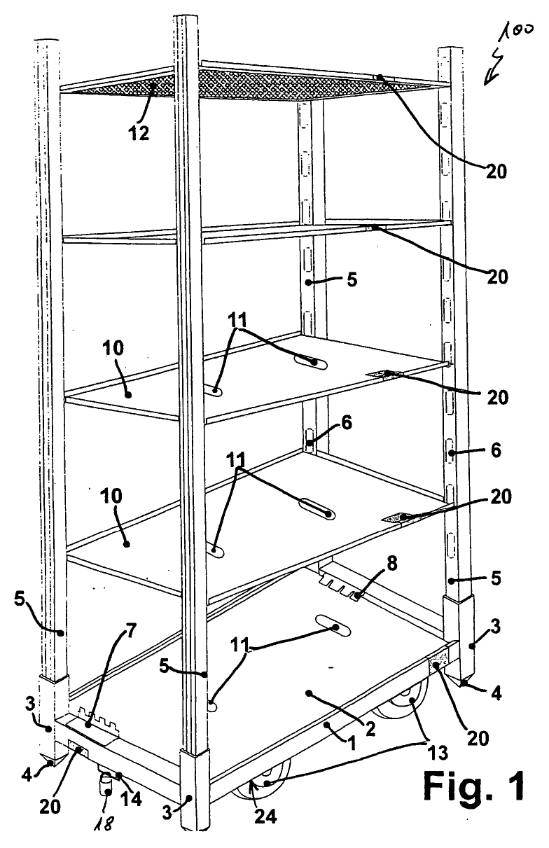

FIG. 1 shows a roll container of the invention with two spaced-apart fixing means for corner posts,

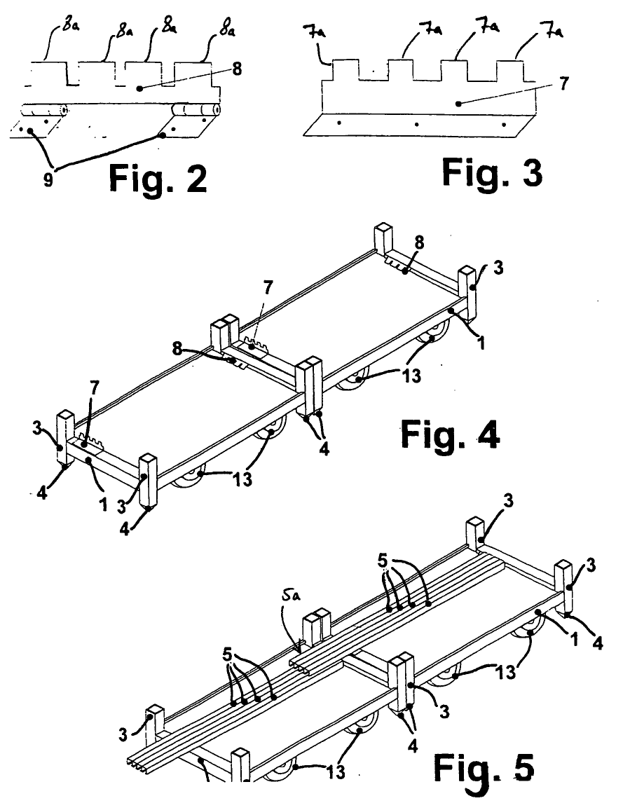

FIG. 2 shows a fixing element pivotally carried on hinges for longitudinal insertion into corner posts,

FIG. 3 shows a stationary fixing element for placing corner posts thereon,

FIG. 4 shows two side-by-side base elements with fixing means according to the FIGS. 1 through 3,

FIG. 5 shows the two side-by-side base elements of FIG. 4 with the corner posts fixed in their horizontal position,

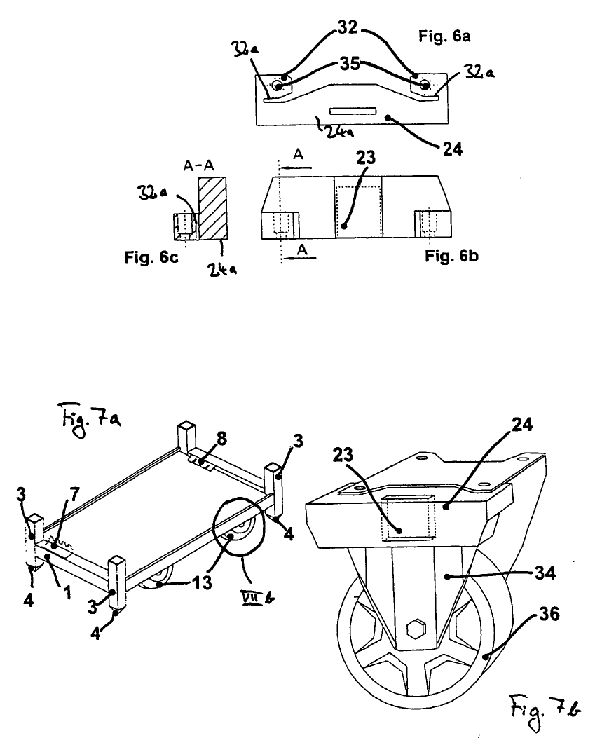

FIG. 6a is a top view of a transponder carrier of the invention,

FIG. 6b is a front view of the transponder carrier of FIG. 6a,

FIG. 6c is a sectional view of the transponder carrier of the FIGS. 6a and 6b taken along the mark A-A in FIG. 6b,

FIG. 7a shows a base element of a roll container according to the FIGS. 1 through 5 with a transponder carrier as shown in FIG. 6,

FIG. 7b shows the fixed caster wheel labelled XIIb in FIG. 7a in an enlarged, isolated view,

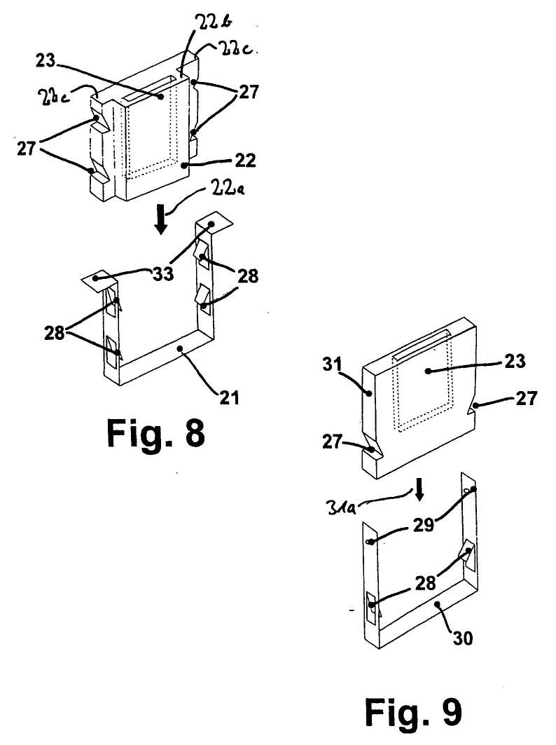

FIG. 8 shows an implementation variant of a transponder carrier and of a retaining device,

FIG. 9 shows an implementation variant of a transponder carrier and of a corresponding retaining device,

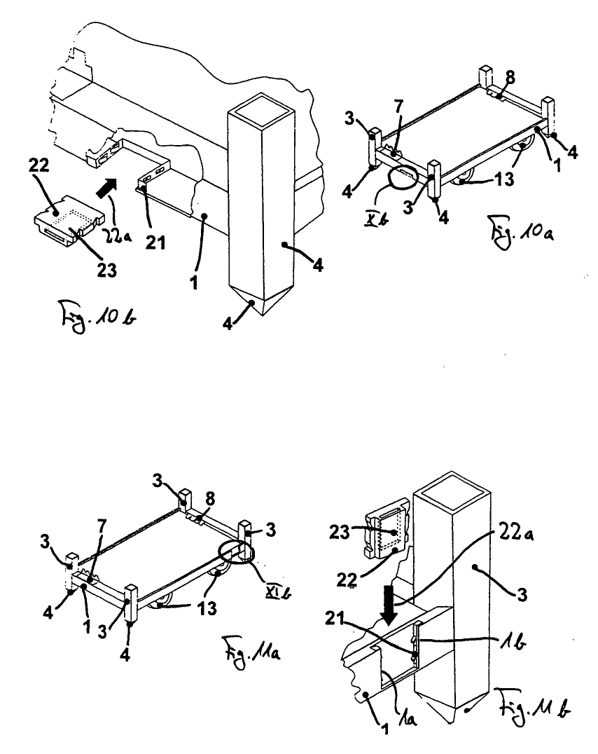

FIG. 10a shows an alternative base element with a transponder carrier disposed on an end side,

FIG. 10b is an enlarged partial view showing the base element of FIG. 10a according to the label Xb provided therein,

FIG. 11a shows another alternative embodiment of a base element with a transponder carrier disposed on the long side, on the frame thereof,

FIG. 11b is an enlarged partial view showing the base element of FIG. 11a according to the label XIb therein,

FIG. 12a shows another implementation variant of a base element with an externally fixed transponder carrier,

FIG. 12b is an enlarged partial view showing the base element of FIG. 12a according to the label XIIb therein,

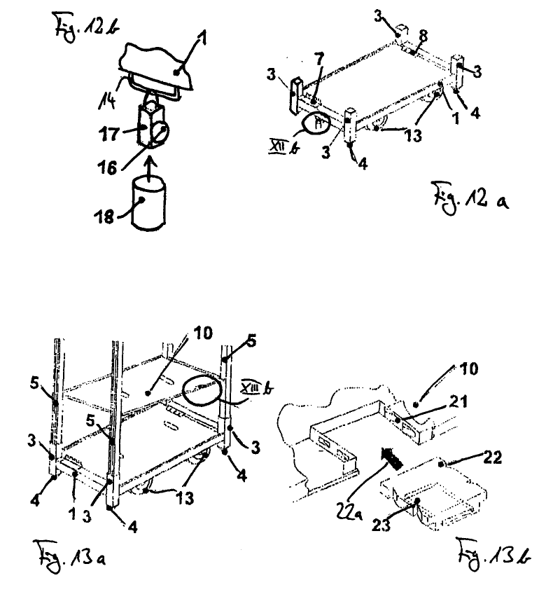

FIG. 13a shows another embodiment of a roll container provided with bottom elements, one bottom element holding a transponder carrier,

FIG. 13b is an enlarged partial view showing the roll container of FIG. 13a according to the label XIIIb therein,

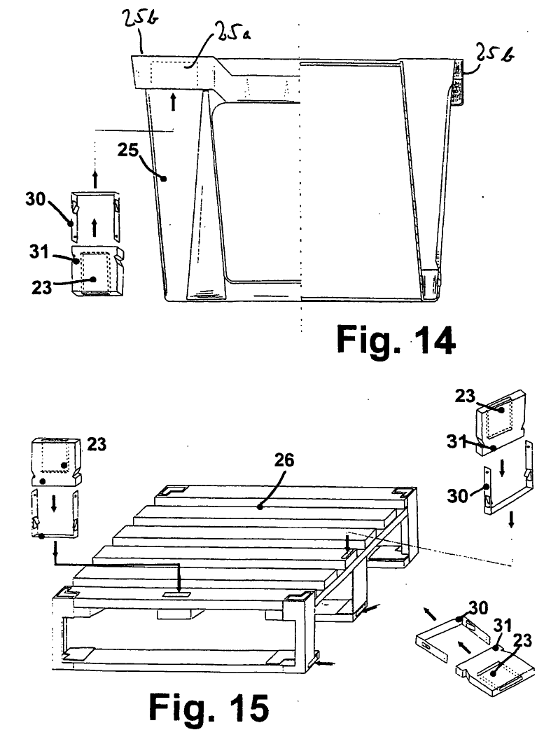

FIG. 14 shows a load collecting container having a transponder carrier firmly integrated in a rim thereof,

FIG. 15 shows a plastic pallet with several outlined possible locations for attaching the transponder carrier,

FIG. 16 shows a plug-shaped transponder carrier of the invention having the shape of a slotted cylinder,

FIG. 17 shows an implementation variant of a transponder carrier of the invention in the shape of an open partial cylinder,

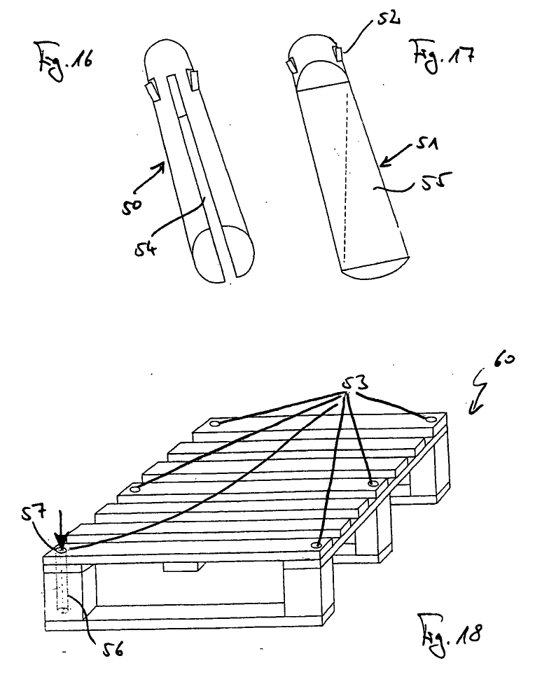

FIG. 18 shows a commercially available wood pallet with outlined preferred locations for attaching the transponder carrier according to the FIGS. 16 and 17,

FIG. 19 is a schematic view showing the insertion position of a retaining spring in a transponder carrier according to FIG. 17,

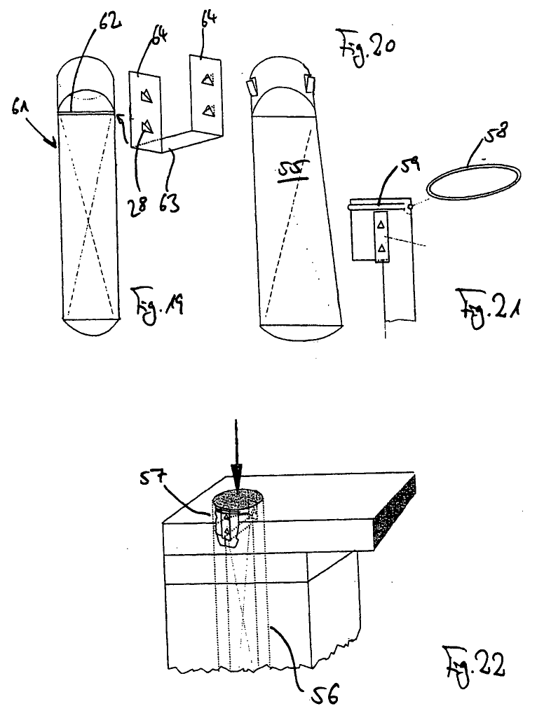

FIG. 20 shows the transponder carrier of FIG. 19 with inserted retaining spring,

FIG. 21 is a schematic view showing how a sealing ring is mounted in a groove on a transponder carrier according to the FIGS. 17, 19 and 20 and

FIG. 22 is a schematic view showing how a plug-shaped transponder carrier is mounted in a pallet.

The roll container 100 in FIG. 1 substantially consists of a base element 1 having caster wheels 13 disposed at its bottom and a base plate 2 that is placed in the frame of the base element 1. At its four corners, the base element 1 has post retainers 3. Corner posts 5 are stuck therein so as to be slightly clamped and so that they 5 are standing vertically upright. The corner posts have a perforation 6 into which bottom plates 10 with recessed grips 11, grid shaped bottom plates 12 and/or any other elements such as container elements 25 or pallet elements 26 may be hung.

The frame of the base element 1 and, as a result thereof, the major part of the base element, is made from a metal for the base element to be as robust as possible and to also be capable of receiving the necessary loads for a long time even when subjected to intensive mechanical load. The base bottom plate 2 may be formed from a metallic material or from another suited material. The same applies to the other bottom plates 10, 12, 25, 26.

At the lower end 4, each post retainer 3 has a pointed end. A plurality of base elements 1 can be stably stacked at their pointed ends because the pointed end of an upper base element engages into the post retainer of a base element located underneath.

The base element 1 has four caster wheels 13. Two of the four caster wheels are rotatable 360°, the other two are configured to be fixed caster wheels, meaning, they cannot rotate.

The rigid spacer 7 at a first end side of the base frame of the base element 1 comprises four stationary, upward directed bearing lugs 7a. Said bearing lugs can engage into the perforation 6 or into a continuous groove on the opposite side of the posts 5 in the horizontal position thereof (see FIG. 5) so that the posts 5 are kept from sliding laterally out of place.

On the opposite end side of the base element 1 there is disposed the holder 8 that is movably carried via a hinge 9. Bearing plugs 8a provided thereon can engage longitudinally from the bottom into the horizontally stacked posts 5, thus also securing the posts 5 against slipping out of place. Since the horizontally posts 5 carried on the stationary spacer are slightly elevated, they are slightly inclined with respect to the base element 1. In this way, two base elements can be placed so that their end sides are immediately adjacent, protruding ends 5a of the posts 5 coming to lie above the posts 5 of the neighboring base element when the posts 5 of the two neighboring base elements 1 are inclined in the same direction. This is an arrangement for transporting empty containers that is particularly space-saving while still providing for safe transport.

On a suspension sheet 34 (see FIG. 7a and FIG. 7b in particular), there is disposed a transponder carrier 24 (see FIGS. 6a, 6b, 6c) that has been specially conceived for being utilized thereon. A stationary fixed caster wheel 13 has been chosen for this purpose in order for the transponder to be prevented from rotating out of its alignment with the base element 1 and, as a result thereof, to enable it to be read out with operational safety.

The transponder carrier 24 very substantially consists of a relatively plane carrier body 24a and of two wings 32 disposed at the ends thereof. Between the carrier body 24a and the wings 32 there are formed two slots 32a for receiving the suspension sheet 34. The carrier body 24a readily engages into a straight connection between the slots 32a so that a curved sheet 34 is allowed to interlockingly engage into the slots 32a to a large extent. This stabilizes the transponder carrier 24 in its assembled position on the suspension sheet 34 for the caster wheel 36.

In the carrier body 24a of the transponder carrier 24, there is provided a transponder pocket 23 for receiving the transponder chip as such. As soon as the transponder chip as such has been inserted into the transponder pocket 23, the opening can be thermally soldered or sealed in another way so that dirt and humidity are no longer allowed to reach the transponder chip itself. The plastic material of the transponder carrier 24 also protects the chip as such from adverse influences.

In the mounted condition, the wings 32 of the transponder carrier 24 surround the suspension sheet 34 of the fixed caster wheel 13 so that the transponder lies on the outward turned side of the suspension sheet 34, whilst the fastening and the screws provided for this purpose are to be found on the opposite side of the suspension sheet 34 and, as a result thereof, directed beneath the base element. Screw holes 35, the size and position of which are adapted to the screws (not shown) that are located on the suspension sheet 34 anyway, are preferably already provided in the wings 32. In this manner, the existing screws for holding the suspension sheet 34 may be additionally used directly for fixing the transponder carrier 24 to the base element 1.

The transponder carriers 22 or 31 (see FIGS. 8, 9 in particular) are not so much provided for being utilized directly on suspensions of fixed caster wheels but rather for being pushed into recesses. Each of them has a transponder pocket 23 for receiving the transponder chip as such. They each communicate with a retainer spring 21 or 30, anchor wings 28 being provided on either spring 21, 30, said anchor wings snap-fitting into detent recesses 27 on the transponder carrier 22 or 31 as soon as they are pushed in the direction of insertion 22a or 31a, past the anchor wings 28, into the retaining springs 25 or 30. The anchor wings 28 make it impossible to remove the transponder carriers 22 or 31 from the retaining springs 21 or 30 without destroying them once they have snapped into the recesses. The retaining springs 21 or 30 are anchored with nails, screws or similar to the container, the base element thereof or to a bottom element through fixing angles 33 and/or through fixation holes 29.

As compared to the transponder carrier 31, the transponder carrier 22 has the peculiarity that it has two wing elements 21c located behind an actual carrier body 22, the detent recesses 27 being disposed on said wing elements. If the recess in the base element 1 is appropriately configured (see FIGS. 11a, 11b) and has two protruding retaining lips 1a, 1b, this provision also makes it impossible for the transponder carrier 22 to be removed from the frame of the base element 1 in a direction perpendicular to the direction of insertion 22a.

As compared thereto, if desired, the transponder unit consisting of the transponder carrier 31 and the retaining spring 30 may also be consciously utilized to secure a transponder carrier during utilization whilst it may be pulled off laterally after use and replaced by another transponder for example.

It is explicitly noted that a transponder carrier 22, 31 with or without corresponding retaining springs 21, 30 may also be placed into the transponder pocket 23 of another transponder carrier 24 if it is desired to build the transponder from a plurality of components.

Transponder units 20 may be disposed on different locations on roll containers and other stationary load carriers, for example, beside the base element 1, also on the other bottom plates 10, 12, 25, 26 of a rack container or on a conventional transport pallet 60. Considering that load carriers of the type of the subject matter of the present invention are in most cases transported so that their end side is the first to pass through a scanner gate, it is advisable to dispose them on a long side. Transponder units 20 may however also be provided on an end side or toward a bottom scanner, though. For an orientation toward the bottom in particular, bars 14 may well be used on the load carrier. A transponder unit 16 may for example be disposed on the bar 14 via a brand lock 17 and be sheathed with a protecting sleeve 18 (see FIGS. 12a, 12b in particular).

For mounting a transponder carrier 31 with a securing return spring 30 in a load collector, for example in a container 25 adapted for being hung or for free standing, the best suited part is the rim 25b of the container 25 that protrudes furthest.

A pallet 26 provides for numerous both horizontal and vertical mounting possibilities (see FIG. 15). On wood pallets, the transponder carrier is preferably sunk in one of the lateral logs or fastened to the exterior side of one of them. The logs are quite solid. They join the carrying surface of the pallet to the runners thereof.

The plug-shaped transponder carriers 50, 51 have the same geometry with respect to their envelope. Each of them is insertable into a cylindrical hole with a diameter of about 25 to 30 mm. Directly on the transponder carrier 50, 51, there are provided spreader elements 52 (labelled by way of example) for fixing the transponder carriers 50, 51 in a corresponding recess 53 (see FIG. 18), once they are sunk therein.

In the transponder carrier 50 there is provided a slot 54 for receiving the actual transponder chip and for secure storage thereof. Over a wide range of the transponder carrier 51, there is provided only one semi-cylinder so that there is provided a large, freely accessible carrying surface for the transponder 55 to which the transponder may for example be simply glued. In both cases, the transponder carrier sunk into the recess 56 (see FIG. 18) is simply sealable on its opening 57, for example with an O-ring 58 (see FIG. 21) made from a rubber material that is placed into a corresponding groove 59 on the transponder carrier, a clamping registration fit being achieved between said O-ring 58 and the opening 57.

A variant of a very cheap to manufacture return safety element for a transponder carrier can be achieved by providing, in a transponder carrier 61 (see FIG. 19), an insertion slot 62 that is disposed so as to be preferably approximately perpendicular to the longitudinal extension of the transponder carrier 61. A retaining spring 63, which may be formed at low cost with simple means, can be inserted from the side so that two lengthwise oriented metal straps fit laterally against the transponder carrier 61, with the anchor wings 28 (labelled by way of example) for anchoring the transponder carrier 61 protruding therefrom.

It is explicitly noted that a plug-shaped transponder carrier of the type proposed is particularly suited for being placed into wood. Since a hole made in wood normally has quite rough an inner surface, the transponder carrier can be simply pushed into such a hole. If the transponder carrier has laterally protruding elements such as retaining springs or other projecting elements, a very stable cant with the wood is achieved without having to further process the surface of the hole. Accordingly, the transponder carrier cannot be pulled out of the wood pallet nor is it allowed to rotate out of place therein.

On this particular background, in a particularly preferred embodiment of the invention, the plug-shaped transponder carrier is sunk in a log 70 of a pallet 60.

Therefore, to retrofit a conventional wood pallet, it is proposed that a hole be made in the log of the pallet and that a transponder carrier be sunk into said hole. To retrofit a rollable load carrier, by contrast, it is particularly suitable to utilize the suspension of the fixed caster wheel to fasten the retrofitted transponder.

Generally, the containers and load carriers shown can be used for transport, storage and/or for the entire logistic procedure during handling of diverse goods. Load carriers and load collectors of this type are often available in a pool system. The load carriers and load collectors are of great value so that uninterrupted control of both the goods and the load carriers and load collectors should be ensured. Any information can be stored on the transponders and both active and passive transponders can be utilized. A plurality of transponders can also be provided on one logistic unit. UHF chips having an emitting frequency of 868 MHz are preferably utilized as the transponder chips because they have a very good coverage. Alternatively, chips in HF with a frequency of 13.56 MHz may also be envisaged. These however only have a very small coverage of about 30 to 50 cm so that their suitability for use in the transfer of goods is very limited.

### LIST OF NUMERALS

1 base element
1a, 1b retaining lips
2 base bottom
3 post retainer
4 bottom end
5 post
6 perforation
7 spacer
7a bearing lug
8 holder
8a bearing plug
9 hinge
10 bottom plate
11 recessed grips
12 grid shaped bottom plate
13 roll
14 bar
16 transponder unit
17 brand lock
20 transponder unit
21 safety retaining spring
22 transponder carrier
23 transponder pocket
24 transponder carrier
24a carrier body
25 container bottom plate
25a recess
26 pallet bottom plate
27 detent recess
28 anchor wing
29 fixation hole
30 safety return spring
31 transponder carrier
32 wing
32a slot
33 fixing angle
34 suspension sheet
35 screw hole
36 caster wheel
50, 51 transponder carrier
52 spreader
53 positioning holes
54 reception slot
55 transponder carrying surface
56 hole
57 opening
58 O-ring
59 groove
60 wood pallet
61 transponder carrier
62 insertion slot
63 spring made of metal
64 side element
70 log of the pallet

1-27. (canceled)

28: A rollable load carrier, with an RFID transponder, said RFID transponder being disposed on a transponder carrier that is non-twistably and non-displaceably connected to said load carrier, irrespective of the load disposed or adapted to be disposed on said load carrier, characterized in that the transponder carrier is fastened to a suspension of a fixed caster wheel.

29: The load carrier as set forth in claim 28, wherein the transponder carrier forms a grip around the suspension toward the 10 caster wheel.

30: The load carrier as set forth in claim 28, wherein the transponder carrier has two spaced apart and/or relatively angled slots.

31: The load carrier as set forth in claim 28, wherein the transponder is spaced at least about 15 mm, more specifically at least about 20 mm, apart from the suspension.

32: The load carrier as set forth in claim 28, wherein the transponder carrier utilizes existing 20 fastening means of the suspension.

33: The load carrier as set forth in claim 28, wherein the transponder carrier directs the transponder toward a side edge of the load carrier so that the transponder may be read out from a laterally disposed scanner or that the transponder carrier orients the transponder toward an underside of the load carrier so that the transponder can be read by a scanner disposed in the bottom plate.

34: A load carrier, more specifically a pallet, with an RFID transponder, said RFID transponder being disposed on a transponder carrier that is non-twistably and non-displaceably connected to said load carrier, irrespective of the load disposed or adapted to be disposed on said load carrier, wherein the transponder carrier is sunk in a recess provided in the load carrier.

35: The load carrier as set forth in claim 34, wherein the transponder carrier is at least substantially configured in the shape of a plug.

36: The load carrier as set forth in claim 34, wherein the recess is a hole.

37: The load carrier as set forth in claim 34, wherein the transponder carrier has a clamping registration fit with the recess at the opening thereof.

38: The load carrier as set forth in claim 34, comprising a detent device that opposes a destruction-free removal or rotation of the transponder carrier out of the recess.

39: The load carrier as set forth in claim 34, wherein the transponder carrier is disposed in a log of a pallet.

40: A load collector, more specifically configured in the shape of a crate or a container and having a RFID-transponder, wherein the RFID-transponder is disposed on a transponder carrier that is non-twistably and non-displaceably connected to the load carrier, irrespective of the load disposed or adapted to be disposed in said load collector.

41: A load carrier with a brand lock that is fastened to a bar on a frame of the load carrier, wherein the bar protrudes outward from the load carrier, on one end side in particular, and that an RFID-transponder is provided on the brand lock so that the transponder can be read out from a position at the side and/or above the load carrier.

42: A transponder carrier for use in an arrangement as set forth in claim 28, with a load carrier or with a load collector.

43: The transponder carrier as set forth in claim 42, wherein the transponder carrier has at least substantially the shape of a plug.

44: A method for providing a movable load carrier with an RFID-transponder, wherein the transponder carrier is fastened to the side of a fixed caster wheel.

45: A method for providing a pallet with an RFID-transponder, wherein a hole is made in a leg log of the pallet and that a plug-shaped transponder carrier is then sunk into said hole.
